(19) United States
(12) Patent Application Publication
(10) Pub. No.: US 2003/0042796 A1
(43) Pub. Date: Mar. 6, 2003

(54) Automatic power outlets

(76) Inventor: Donald Siu, Santa Ana, CA (US)

Correspondence Address: Donald Siu, 2522 S. Deegan Drive, Santa Ana, CA, 92704, US

(21) Appl. No.: 09/930,709

(22) Filed: Aug. 16, 2001

(51) Int. Cl. H02J 1/00

(52) U.S. Cl. 307/39

(57) ABSTRACT

The Automatic Power Outlets described herein delivers power to the auxiliary devices automatically upon detecting the ON state of the master device, and removes power from the auxiliary devices automatically upon detecting the OFF state of the master device. However, said Automatic Power Outlets will not be energized upon detecting a low standby/sleep current that some master devices may exhibit as part of their off-state characteristic. Said Automatic Power Outlets are simple to build, low in cost and conveniences to user. Said conveniences allow the user to assign any electrical device as the master, and eliminate the routine task of switching the supporting devices on and off in the system.

### REFERENCES CITED

REFERENCES CITED

| U.S. Pat. Documents | | |
|---|---|---|
| 4054802 | October 1977 | Mock |
| 4675537 | June 1987 | Mione |
| 5579201 | November 1996 | Karageozian |
| 6211581 | April 2001 | Farrant |

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### DESCRIPTION

1. Field of the Invention

This invention generally relates to electrical power outlets or electrical power strip. It particularly relates to electrical current sensing, electrical voltage measurement, analog signal processing, electrical power control, electrical power switching, and electrical power distribution.

2. Background of the Invention

In the fields of home computer system, office computer system and home entertainment center, there exists a need to connect multiple devices into one common power strip. For example, in the computer system one normally plugs the computer, video monitor, amplified speakers, printer, scanner and other peripheral devices into one common power strip. The system is turned on by first turning on the power strip, then turning on the computer, and finally turning on the rest of the system devices. In this case, the computer plays the role of the master device while all other devices connecting to the same power strip play the supporting functions such as displaying, sounding, printing, scanning, etc.

The same can be said of home entertainment center where the AV receiver plays the role of the master device while all other components, such as TV/monitor, VCR, CD/DVD player, satellite receiver, cable set-top box, etc. play the supporting functions.

U.S. Pat. No. 5,579,201 to Karageozian shows a power strip with two AC electrical power cords, primary and secondary, the primary cord connects to the wall outlet while the secondary cord connects to the switched outlet of the AV receiver or computer. This device has two disadvantages. Firstly, it requires a second AC cord connecting the power strip to the master device. Secondly, it requires that the master device must have a switched outlet that is needed to power its internal relay.

U.S. Pat. No. 4,675,537 to Mione shows a power strip with its internal control circuits connecting directly to AC main without any mean of protection such as electrical isolation, fuse and/or circuit breaker. Said power strip does not detect standby current which is now common to most electrical devices with memory retention or time keeping functions. Whenever power switch is turned off, said devices go into standby or sleep mode, and draw a low standby current.

It is apparent that there is a need for an automatic power strip that automatically delivers power to the auxiliary devices once the master device is turned on, and automatically removes power from the auxiliary devices once the master device is turned off. However, said automatic power outlets will not be energized upon detecting a low standby/sleep current that some master devices may exhibit as part of their off-state characteristic.

### SUMMARY OF THE INVENTION

The object of this invention is to provide automatic power outlets for automatic delivery of 120VAC power to the auxiliary devices on command from the master device.

It is an object of this invention to provide a power strip similar in appearance as a conventional power strip, but with the exception that said power strip employs no power switch, and that it has two different sections of power outlets. The first section contains one master outlet that is always on when the power cord of said power strip is plugged into the wall where 120VAC is available. The second section contains a plurality of outlets that are automatically switched on when the master device, plugged into the master outlet, is turned on, and are automatically switched off when the master device is turned off.

It is an object of this invention to provide automatic power outlets that are controlled manually by the master device's power switch, and remotely by the master device's remote control power on/off. Said remote control can be wired or wireless.

It is an object of this invention to provide automatic power outlets that are simple to build, low in cost and conveniences to user. Said conveniences allow the user to assign any electrical device as the master, and eliminate the routine task of switching the supporting devices on and off in the system.

It is an object of this invention to provide one master power outlet and a plurality of automatic power outlets in one common housing.

It is an object of this invention to provide automatic power outlets that are energized by electromagnetic detection and sensing method, thus providing electrical isolation from the AC main.

It is an object of this invention to provide automatic power outlets that use a current transformer as a current sensing device. Said device consists of a ferrite core, a multi-turn secondary winding that wraps tightly around the inner and the outer surfaces of said ferrite core, and the primary winding is the AC wire that is looped through said ferrite core. Said AC wire supplies power to the master outlet.

It is an object of this invention to provide automatic power outlets that offers full electrical isolation from the AC main. The current transformer electrically isolates the sensing circuit from the master outlet's AC current, while the power transformer electrically isolates the control circuit from the AC main, thus providing full protection from possible fire hazard and electric shock.

It is an object of this invention to provide automatic power outlets that allow user to select or adjust different level of standby current. Said standby current selection is necessary for those master devices, while in their off-state, draw small amount of AC current. This feature prevents the automatic power outlets from turning on while the master device is in its off state or in its standby/sleep mode.

### BRIEF DESCRIPTION OF THE DRAWINGS

FIG. 1 is a schematic diagram of the Automatic Power Outlets showing all circuits assembled within the enclosure.

FIG. 2 is the top and side views of the Automatic Power Outlets enclosure.

FIG. 3 is the bottom view of the Automatic Power Outlets showing the standby current switch.

### DETAILED DESCRIPTION OF THE INVENTION

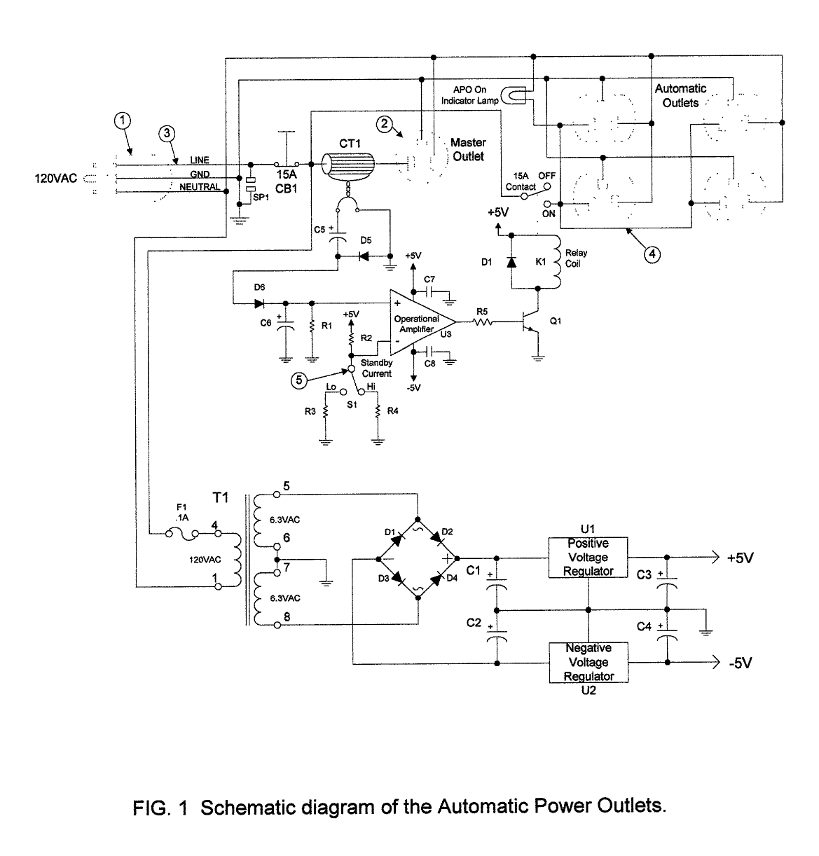

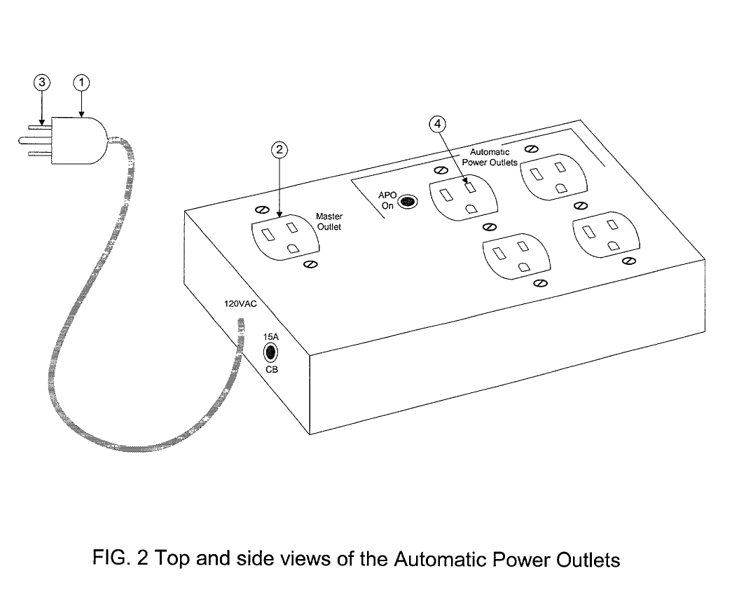

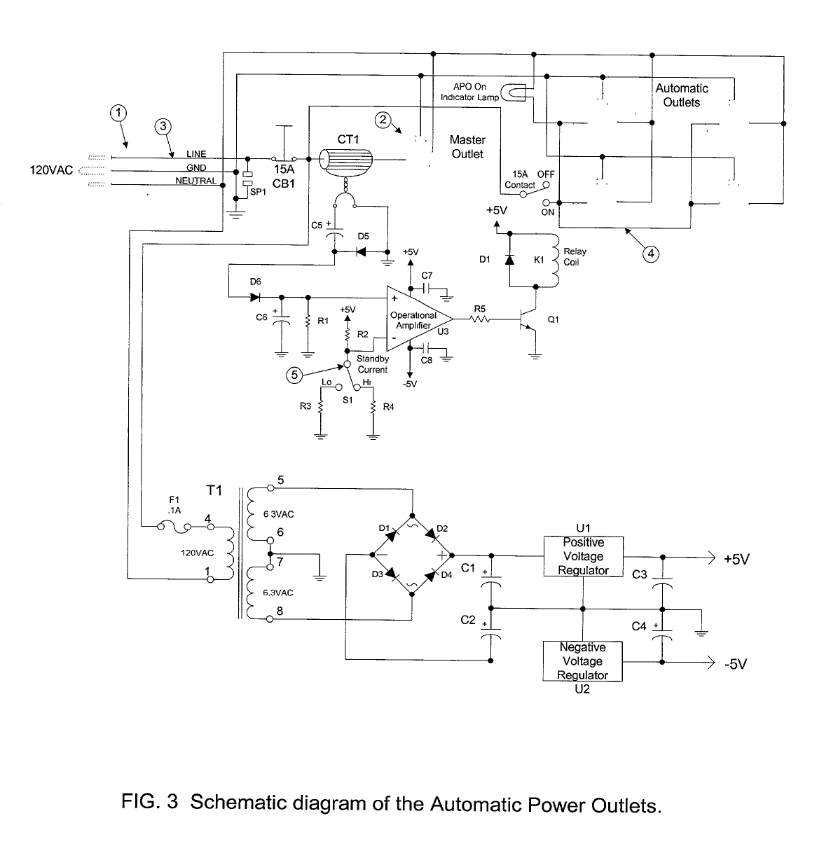

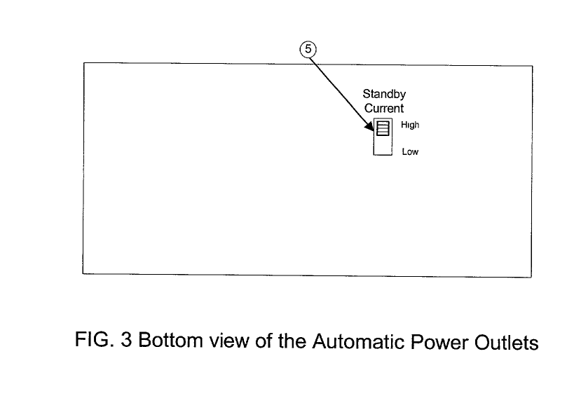

Reference to FIG. 1, the invention consists of a current transformer acting as the master load current sensor, a voltage doubler, a voltage comparator, a standby current switch, a power switch relay, an Automatic Power Outlets (APO) on indicator and a power supply.

The operation begins with the AC plug \mathring{1} being plugged into the wall outlet where 120VAC is present. The power supply, consisting of T1, D1, D2, D3, D4, C1, C2, C3, C4, U1 and U2, is powered on supplying power to the comparator U3 and the relay K1. The 120VAC is also present at the master outlet \mathring{2}.

Next, a master device, which can be a computer, an AV receiver or any other electrical equipment, is connected to the master outlet \mathring{2}. When the power switch of the master device is turned on, the AC current coming from the AC plug \mathring{1}, passing through the current transformer CT1 and supplying power to the master outlet \mathring{2} causes transformer CT1 to generate, by way of electromagnetic induction, a low AC voltage at its secondary winding. This low AC voltage is directly proportional to the master load current. This method of sensing provides electrical isolation from the AC main, thus ensuring safety. The CT1 secondary AC voltage is then rectified, filtered, the resultant DC voltage is doubled, and is present at the positive input of U3. The components involved in this process are D5, D6, C5, C6 and R1.

The sensed voltage at the positive input of U3 is then compared with the reference voltage at the negative input of U3. This reference voltage is set by the switch S1 \mathring{5} that provides two levels of sensing, low and high standby current. The low standby current corresponds to a master device when in its off state draws zero or very low current (less than 0.01 Amp. AC). The high standby current corresponds to a master device when in its off state draws considerable amount of current (up to 0.1 Amp. AC).

When switch S1 is in high standby current mode, the Automatic Power Outlets do not turn on upon detecting a threshold current of less than 0.1 Amp. When a current of over 0.1 Amp. is detected, U3 output changes from V− to V+. This V+ voltage turns on Q1, causing relay K1 to switch on, connecting the line current from \mathring{3} to \mathring{4}, and supplying AC power to Automatic Outlets. Diode D1 is used to keep the relay contacts from chattering and to protect transistor Q1 from current transients during switching transitions. This mode of operation works with a master device when in its off state draws high standby current that is needed to keep its internal clock running and its memory fresh.

Similarly, when switch S1 is in low standby current mode, the Automatic Power Outlets do not turn on upon detecting a threshold current of less than 0.01 Amp. When a current of over 0.01 Amp. is detected, the Automatic Power Outlets turn on, supplying AC power to auxiliary devices whose AC plugs connected to these outlets. This mode of operation works with a master device when in its off state draws low or zero standby current.

The current transformer CT1 is constructed using a ferrite core of sufficient inner diameter to accommodate both the one-turn primary and the multiple-turn secondary windings. The invention uses a ferrite core of 0.25-inch inner diameter with 70-turn of 30 AWG enamel wires that wrap tightly around the inner and outer surfaces of said ferrite core.

What I claim as my invention is:

1. A device, called Automatic Power Outlets, for the automatic delivery of power to a plurality of auxiliary devices comprising:
(a) A wiring circuit board containing a current sensor, a power supply, an electronic signal processing circuit, a standby current switch and a relay.
(b) An AC power cord.
(c) A circuit breaker.
(d) A surge protector.
(e) An Automatic Power Outlets indicator lamp.
(f) A single AC socket receiving a master device's AC plug.
(g) Multiple duplex AC sockets delivering power to auxiliary devices.

2. A plastic or metal enclosure housing all parts of claim 1.

3. A device, called Automatic Power Outlets, for the automatic delivery of power to auxiliary devices, as recited in claim 1, wherein said wiring circuit board further comprises:
(a) A current transformer, acting as a linear AC current-to-AC voltage converter.
(b) A voltage doubler, for converting AC voltage to DC voltage, also doubling the resultant DC voltage.
(c) A DC power supply, supplying power to the on-board electrical and electronic circuits.
(d) A voltage comparator, for comparing a measured DC voltage against a preset reference DC voltage, thus deciding whether the master device is ON or OFF.
(e) A standby current switch, for selecting either a low or high standby current.
(f) An electronic switch, for receiving an ON or OFF command from the voltage comparator, also acting as driver for the relay.
(g) A relay switch, for delivering AC power to the automatic outlets.

4. Said Automatic Power Outlets of claim 1 comprising the use of a ferrite-cored inductor as a current transformer, also functioning as a current sensor, as recited in claim 1.

5. Said Automatic Power Outlets use the existing master device's power on/off switch as a controlling mechanism regardless whether said master device's power control is wired or wireless.

6. Said Automatic Power Outlets of claim 5 do not require a separate remote control, any additional wiring or computer hardware and software interface. The only requirements are that Automatic Power Outlets be plugged into the wall outlet where 120VAC is present, and that master device's AC cord be plugged into the master outlet.

7. Said Automatic Power Outlets of claim 5 are turned on and off simultaneously when the respective power on and off condition of the master device is detected.

8. Said Automatic Power Outlets appearing similar to a conventional power strip, but without having a power on/off switch, instead said Automatic Power Outlets have the characteristics of switching itself on and off automatically in response respectively to the on and off condition of the master device, and keep itself off when detecting a low standby current from the master device. The number of automatic outlets may be increased if needed by connecting a conventional power strip into one of the available automatic outlets.
